(19) United States
(12) Patent Application Publication
(10) Pub. No.: US 2023/0229934 A1
(43) Pub. Date: Jul. 20, 2023

(54) HYPOTHESIS SCORING METHOD BASED ON CAUSAL RELATIONSHIP

(71) Applicant: INTERNATIONAL BUSINESS MACHINES CORPORATION, Armonk, NY (US)

(72) Inventors: Futoshi Iwama, Tokyo (JP); Sachiko Yoshihama, Kawasaki-shi (JP); Issei Yoshida, Setagaya-ku (JP); Naoto Sato, Kawasaki-shi (JP)

(21) Appl. No.: 17/579,095

(22) Filed: Jan. 19, 2022

(51) Int. Cl. G06N 5/02

(52) U.S. Cl. CPC G06N 5/02

(57) ABSTRACT

A computer implemented method of hypothesis scoring based on causal relationships is provided. The computer implemented method includes creating a causal relationship model utilizing a plurality of hypotheses and a causal relationship between each of two or more pairs of hypotheses, and obtaining pro and con sentiment scores for each hypothesis utilizing a scoring function. The computer implemented method further includes assigning the obtained pro and con sentiment scores to each hypothesis in the causal relationship model, and propagating the pro and con sentiment scores from leaf hypotheses to a root hypothesis utilizing axioms to test the propagating scores for reasonableness. The computer implemented method further includes determining a final pro and con score for the root hypothesis, and presenting the final pro and con scores representing a prediction of the hypotheses to a user.

### BACKGROUND

The present invention generally relates to a hypothesis scoring method, and more particularly to a hypothesis scoring method based on causal relationships.

An Abstract Argument Framework (AAF) has provided scoring methods for ranking argument statements that attacks each other based on an attack relation. Scoring claim statements based on relationship knowledge between the statements may only utilize the “attack” relationship. A number of NLP techniques have been proposed to extract various sentiment information from news articles and other linguistic resources. However, in general, a machine-computed score for a hypotheses about individual events tends to be less reliable than more general hypotheses because there is less relevant data available for generating a score.

### SUMMARY

In accordance with an embodiment of the present invention, a computer implemented method of hypothesis scoring based on causal relationships is provided. The computer implemented method includes creating a causal relationship model utilizing a plurality of hypotheses and a causal relationship between each of two or more pairs of hypotheses, and obtaining pro and con sentiment scores for each hypothesis utilizing a scoring function. The computer implemented method further includes assigning the obtained pro and con sentiment scores to each hypothesis in the causal relationship model, and propagating the pro and con sentiment scores from leaf hypotheses to a root hypothesis utilizing axioms to test the propagating scores for reasonableness. The computer implemented method further includes determining a final pro and con score for the root hypothesis, and presenting the final pro and con scores representing a prediction of the hypotheses to a user.

In accordance with another embodiment of the present invention, a computer system implementing a hypothesis scoring method based on causal relationships is provided. The computer system includes one or more processors, a display operationally coupled to the one or more processors, and a computer memory operationally coupled to the one or more processors. The computer system further includes a hypothesis scoring tool stored in the computer memory and configured to create a causal relationship model utilizing a plurality of hypotheses and a causal relationship between each of two or more pairs of hypotheses; obtain pro and con sentiment scores for each hypothesis utilizing a scoring function; assign the obtained pro and con sentiment scores to each hypothesis in the causal relationship model; propagate the pro and con sentiment scores from leaf hypotheses to a root hypothesis utilizing axioms to test the propagating scores for reasonableness; determine a final pro and con score for the root hypothesis; and present the final pro and con scores representing a prediction of the hypotheses to a user.

In accordance with yet another embodiment of the present invention, a computer program product for implementing a hypothesis scoring method based on causal relationships, the computer program product comprising a computer readable storage medium having program instructions embodied therewith is provided. The program instructions are executable by a processor to cause a computer to create a causal relationship model utilizing a plurality of hypotheses and a causal relationship between each of two or more pairs of hypotheses; obtain pro and con sentiment scores for each hypothesis utilizing a scoring function; assign the obtained pro and con sentiment scores to each hypothesis in the causal relationship model; propagate the pro and con sentiment scores from leaf hypotheses to a root hypothesis utilizing axioms to test the propagating scores for reasonableness; determine a final pro and con score for the root hypothesis; and present the final pro and con scores representing a prediction of the hypotheses to a user.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram showing an example of a causal relationship model composed of hypothesis nodes and causations, in accordance with an embodiment of the present invention;

FIG. 2 is a block/flow diagram showing pro/con scores for a hypothesis and topics provided by an external scoring function, in accordance with an embodiment of the present invention;

FIG. 3 is a block/flow diagram showing total scores from the pro/con scores for a hypothesis and topics provided, in accordance with an embodiment of the present invention;

FIG. 4 is a block/flow diagram showing propagated scores from the pro/con scores for a hypotheses and topics, in accordance with an embodiment of the present invention;

FIG. 5 is a block/flow diagram showing propagated r-scores from the pro/con scores for a hypothesis and topics provided, in accordance with an embodiment of the present invention;

FIG. 6 is a block/flow diagram showing a method of obtaining a prediction for a root node, in accordance with an embodiment of the present invention;

FIG. 7 is a block/flow diagram showing propagated r-scores from the pro/con scores for a hypothesis and topics provided, in accordance with an embodiment of the present invention;

FIG. 8 is a block/flow diagram showing a method of obtaining a prediction for a root node, in accordance with an embodiment of the present invention;

FIG. 9 is a block/flow diagram showing a method of propagating the pro and con sentiment scores, in accordance with an embodiment of the present invention; and

FIG. 10 is an exemplary processing system to which the present methods and systems may be applied, in accordance with an embodiment of the present invention.

### DETAILED DESCRIPTION

Embodiments of the present invention provide a system/method for combining sentiment information obtained from news articles with a knowledge base, and utilizing the combination for forecasting or decision making. The system/method provides scores for the hypotheses in the form of pro/con ratios based on knowledge of the causal relationship between different related hypothesis. External voting scores obtained from the news resources for each of the hypotheses are considered for the pro/con ratios. As more specific hypotheses for individual events or companies are considered the scores can be become less reliable due to less availability of relevant data.

Embodiments of the present invention provide a method for propagating pros/cons scores based on causalities of contributory, implication and supervenience causality. Particularly the method of repeating the propagation, so as to meet the axiom of supervenience causality. These axioms realize the evaluation of hypotheses as a reasonable pro/con scoring based on causal relationships. Even in situations where the evaluation score of a hypothesis given by an external function/method/procedure is partially unreliable, it is possible to reasonably re-evaluate each hypothesis based on knowledge of causal relationships.

Embodiments of the present invention provide a method of merging the pro/con score of a hypothetical statement with the pro/con score of a hypothetical statement coupled with the name of a specific entity or individual in order to derive a score for an individual company using only knowledge of a causal model representing a general causal relationship.

Exemplary applications/uses to which the present invention can be applied include, but are not limited to forecasting the stock price and stock volatility of each company, or generating data for these forecasts, and analyzing the reputation of each company, product, or service.

It is to be understood that aspects of the present invention will be described in terms of a given illustrative architecture; however, other architectures, structures, materials and process features and steps can be varied within the scope of aspects of the present invention.

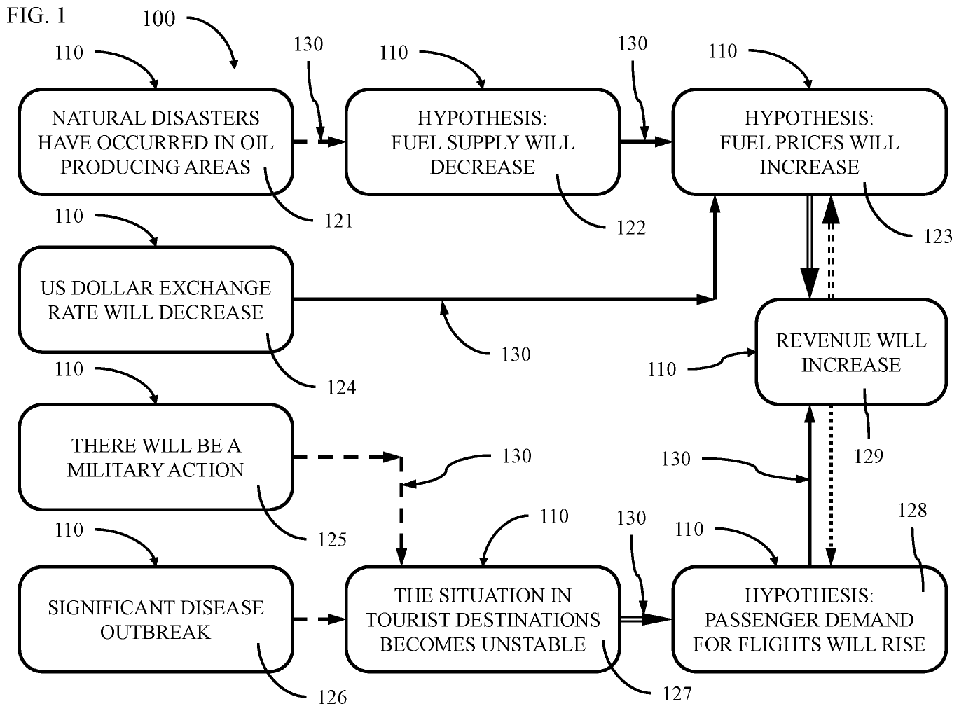

Referring now to the drawings in which like numerals represent the same or similar elements and initially to FIG. 1, FIG. 1 is a block/flow diagram showing an example of a causal relationship model composed of hypothesis nodes and causations, in accordance with an embodiment of the present invention.

In one or more embodiments, a user can create a causal relationship model 100 with hypotheses. The causal relationship models can be expressed as directed acyclic graphs (DAGs) consisting of nodes 110, with each node 110 associated with one of the hypothesis statements 121, 122, 123, 124, 125, 126, 127, 128, 129 (collectively referred to as “12X”), and edges 130 relating to the causations between hypotheses 12X, where three types of causation are introduced for expressing fine-grain causalities. The user can express causal relationship knowledge in the causal relationship model 100 by using three types of causations. Axioms can be used to formally express the degree of reasonable support for the hypotheses, as related by the three types of causation, where the axioms can be incorporated into the edges 130. External sentiment scores can be constrained to satisfy the axioms.

In one or more embodiments, each node 110 expresses a hypothesis 12X. Each hypothesis can contain hypothesis text and topic words. The hypothesis (text) is evaluated in a context related to the topic(s). For example, it is evaluated based on media articles containing all topic words. The hypothesis can be evaluated based on the causal relationship knowledge.

In various embodiments, for example, the hypothesis 129 that “Revenue will rise” can be a root node, and the other hypotheses 121-128 can be other related causal (leaf) nodes.

In various embodiments, the types of causal relationships can be represented as edges between the nodes and capture the knowledge/understanding of the interactions (e.g., cause-effect) between the hypotheses. The types of causality can be represented by the kind of arrows depicting the edges, where a solid line can represent a positive contribution, a double solid line can represent a negative contribution, a dashed line can represent a positive implication, a double dashed line can represent a negative implication, a dotted line represents a positive supervenience, and a double dotted line can represent a negative supervenience.

A positive contribution captures the increased likelihood of the occurrence of the effect (down-stream) hypothesis with the occurrence of the cause (up-stream) hypothesis, and the decreased likelihood of the occurrence of the effect (down-stream) hypothesis with the non-occurrence of the cause (up-stream) hypothesis. A positive implication captures the increased likelihood of the occurrence of the related effect hypothesis with the occurrence of the causal hypothesis. A positive supervenience captures an positive dependency constraint between cause (up-stream) and effect (down-stream) hypothesis in the sense that whenever the cause hypothesis occurs, the effect hypothesis also has to occur.

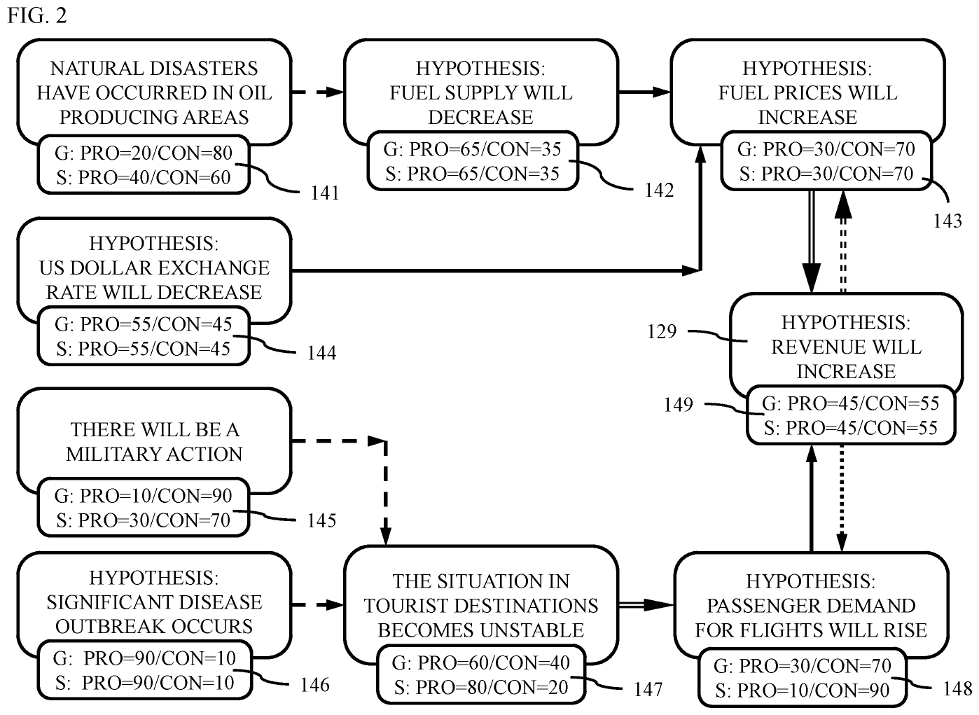

FIG. 2 is a block/flow diagram showing pro/con scores for a hypothesis and topics provided by an external scoring function, in accordance with an embodiment of the present invention.

In various embodiments, a causality model 100 is created by referencing a relatively general event and can further use particular names (e.g. place name, person name, company name) as a parameter for a scoring method. This would allow obtaining scores 141, 142, 143, 144, 145, 146, 147, 148, 149 (collectively referred to as “14X”), for each of the hypotheses both with a specific name (an s-score) and without the specific name as a general score (a g-score), and merging the scores of both the general (g-score) and the specific (s-score) for the hypothesis to form a total score (t-score) for each node/hypothesis. If no specific or singular name is provided by the user, the g-score is regarded as the t-score. A t-score can be calculated as: (g-score.pro+s-score.pro)/2=t.pro; t.con=100−t.pro. In some instances there may be no difference between the general score and the specific score, where the hypothesis is uniform across geographical locations, a business, or an economic sector. A score 149 can be obtained for the root node hypothesis 129, as well scores 141-148 for the leaf node hypotheses 121-128.

The system/method can obtain sentiment pro/con scores 14X, general (g-score) and specific (s-score), for each hypothesis 12X by using an external sentiment extraction tool. The Pro/Con score can be considered as a degree of pro/con supporter production capability, where the number(s) of article(s) are used as weight for the hypotheses. For example, if 1000 articles are utilized in obtaining the pro/con score for the particular hypothesis, then the Log of 1000=3 is applied as a weight to the pro/con score propagated from that particular hypothesis, whereas if 110 articles were utilized in obtaining the pro/con of the hypothesis to which the score is being propagated, then the Log of 110=2 is used as a weight for that pro/con score. For example, 60−40=20; (67*2+20*3)/(100*2+20*3)=75. If only 10 articles included a specific name, Log 10=1 would be a weight that may be applied to just the s-score of the hypothesis before merging g and s scores. If no articles are available for a particular hypothesis, then a weight of 0 is applied and the particular g-score and/or s-score becomes zero (negated). Specific pro/con scores may only consider articles including a specific name. The system/method can then propagate the external sentiment score in a form satisfying axioms for causation types and obtain propagated scores for the hypotheses. A scoring function, H, can be applied to, for example, news articles, to obtain scores for the hypothesis based on the hypothesis text and the identified topic words. The scoring function can utilize an extraction tool that computes the pro/con score of a hypothetical statement by collecting claim statements related to given topic words and applying sentiment extraction natural language processing (NLP) techniques to them.

In various embodiments, the scoring function, H, can be applied to the hypothesis 12X of each node 110 to generate an associated score 14X without utilizing the particular name, that is gpro and gcon. The scoring function, H, can be applied to the hypothesis 12X of each node 110 to generate an associated score 14X utilizing the particular name, that is spro and scon.

In various embodiments, the associated g-scores and s-scores can be merged (e.g., averaged) to obtain a total score, t-score (tpro, tcon) for each node 110.

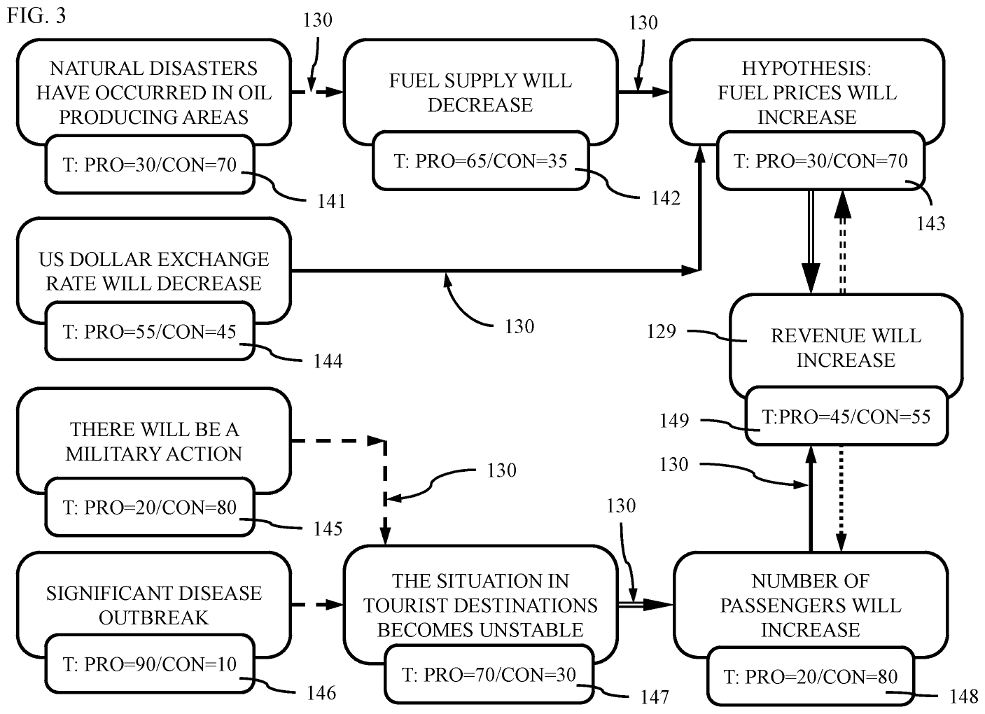

FIG. 3 is a block/flow diagram showing total scores from the pro/con scores for a hypothesis and topics provided, in accordance with an embodiment of the present invention.

In the various embodiments, xpro and xcon represent the pro and con scores applied for each node. gpro and gcon represent the pro and con scores for the general sentiment without a particular name identifier (e.g., person, place, company name, etc.). spro and scon represent the pro and con scores for specific sentiment relating to the particular named identifier. tpro and tcon represent the total pro and con scores after merging the gpro and spro, and gcon and scon. rpro and rcon represent the reasoned/propagated pro score and con score, as calculated.

In various embodiments, the two scores, g-scorer and s-scorer, can be merged as total score, t-score, for each node. For a merge, the t-score is computed as tpro=(spro+gpro)/2 and tcon=(scon+gcon)/2.

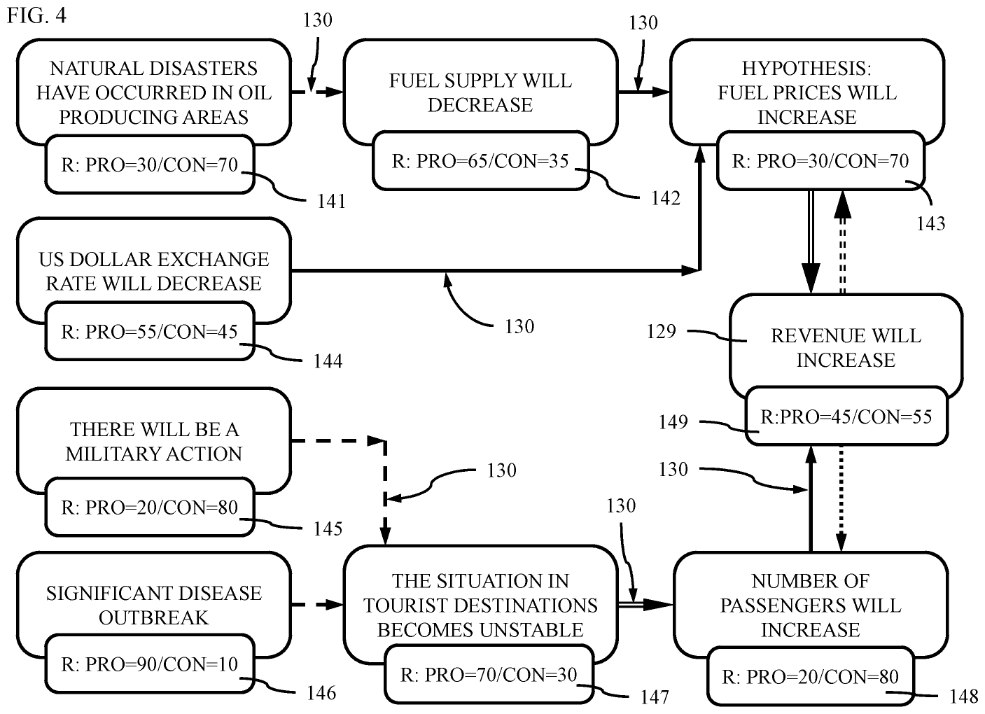

FIG. 4 is a block/flow diagram showing propagated scores from the total pro/con scores for the hypotheses and topics, in accordance with an embodiment of the present invention.

In one or more embodiments, the initial r-scores (rpro, rcon) are set to the same values as the t-scores (tpro, tcon).

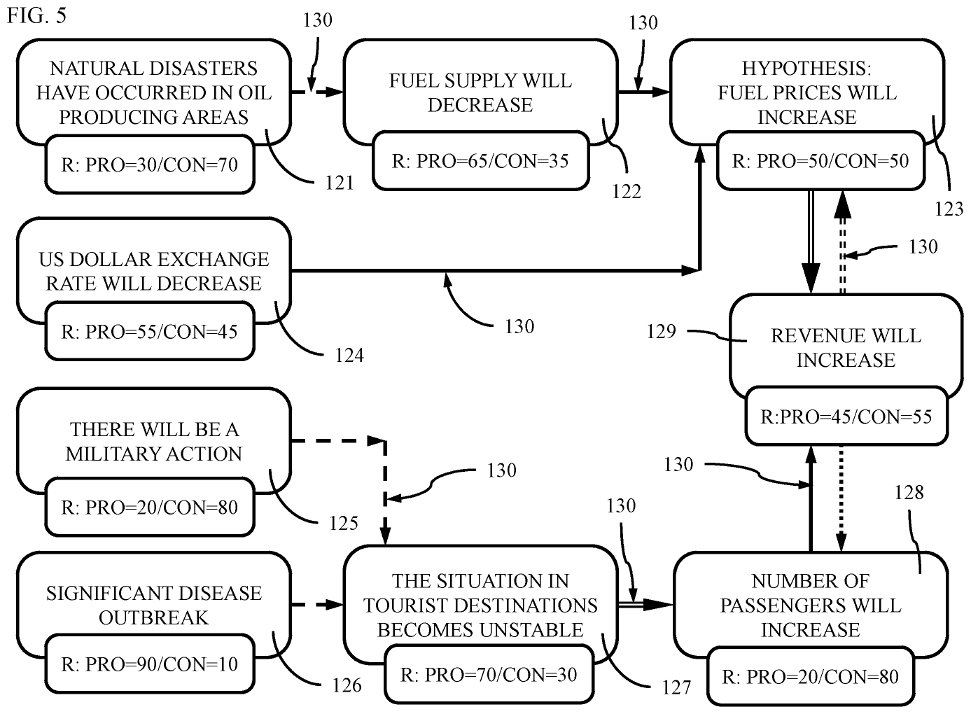

FIG. 5 is a block/flow diagram showing propagated r-scores from the pro/con scores for a hypothesis and topics provided, in accordance with an embodiment of the present invention.

Each edge 130 expresses a causation which is represented by three causation types: a positive contribution, where an occurrence/non-occurrence of hypothesis, A, positively/negatively contributes to the likelihood of the occurrence of hypothesis, B; a positive implication, where the an occurrence of hypothesis, A, positively contributes to the occurrence of hypothesis, B; and positive supervenience, where unless there is an overall positive impact on all the occurrences of B1, . . . , Bk, there will be no positive impact on the occurrence of A.

The axioms formally express the degree of reasonable support for hypotheses related by the above three types of causation and construct pros/cons-scoring methods which constrains external sentiment score propagation to satisfy the axioms. If a hypothesis is evaluated against the axioms and found to be supported, then the hypothesis is propagated to the next stage. If a hypothesis is evaluated against the axioms and found not to be supported, then the propagated value can be set to 50/50 indicating that the g-score and s-score for that hypothesis are not being considered. For example, if a first hypothesis is that the economy is growing and a second hypothesis is that the economy is not growing, both hypotheses cannot be supported (pro values greater than con values) because the contentions are contradictory. The propagated values for both would therefore be reset to 50/50. This case expresses that the external score(s) are not to be trusted because they are inconsistent or contradictory.

A final value is computer for the final hypothesis (i.e., root node), where two scores can be computed; one for pro and one for con. The difference in pro/con score is propagate to each child event for calculating pro/con score of the hypothesis of the child event.

In the situations where a hypothesis is supported, a new value is calculated, as rpro−rcon or rcon-rpro, for each parent (leaf) node, where the smaller value is subtracted from the larger value. For example, hypothesis 121 has rpro/rcon=30/70. Because rcon is larger, 70−30=40, which is forwarded to hypothesis 122. Hypothesis 122 has rpro/rcon=65/35. The combination of the propagated score from hypothesis 121 with the scores of hypothesis 122 results in rpro/rcon of hypothesis 122 remaining 30/70 under Axiom Prop-I because rcon is greater than rpro in hypothesis 121 (this means the score of hypothesis 121 implies that hypothesis 121 does not hold) and positive implication is a relationship that allows the causal hypothesis to influence the resultant hypothesis (down-stream) only when the causal hypothesis (up-stream) holds.

For hypothesis 123, a value of 65−35=30 pro is propagated from hypothesis 122 and combined with the value of 55−45=10 pro from hypothesis 124. The 30 and 10 is combined 30+10=40, which is added to the pro value of hypothesis 123 and evaluated. (30+40)/(100+40)=70/140=0.5*100=50. Con=70/(100+40)=70/145=0.5*100=50.

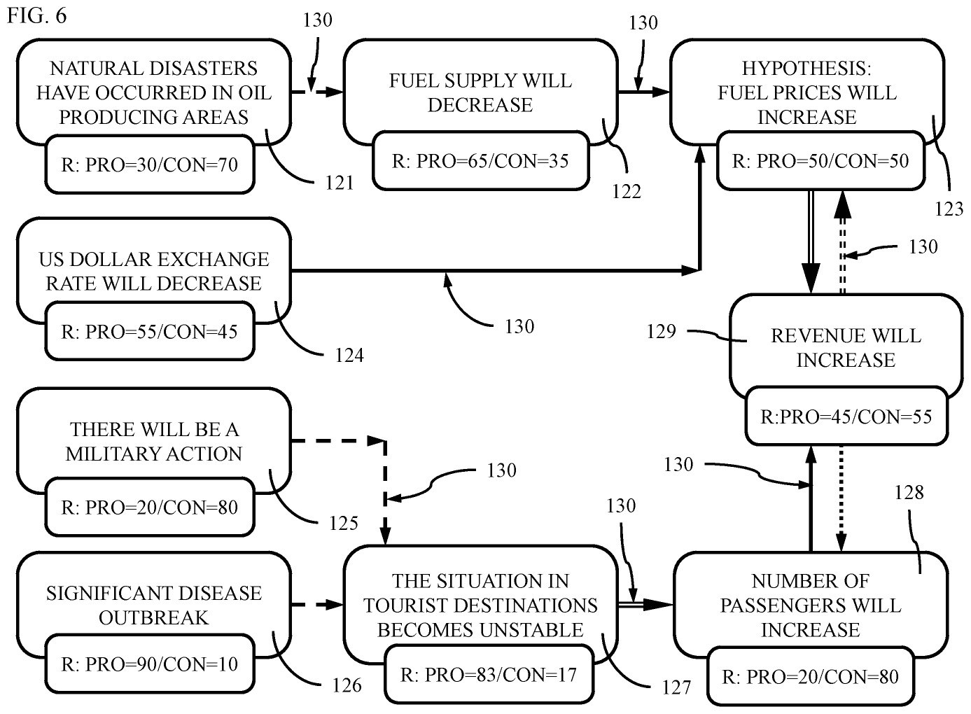

FIG. 6 is a block/flow diagram showing propagated r-scores from the pro/con scores for a hypothesis and topics provided, in accordance with an embodiment of the present invention.

For hypothesis 125, the rpro/rcon=20/80 is not forwarded to hypothesis 127 because 80 (the con value for hypothesis 127) is larger than 20 (the pro value of hypothesis 125) under Axiom Prop I.

In contrast, for hypothesis 126, the rpro/rcon=90/10, so rpro is greater than rcon, and 126 is valid on the score, so there is no axiomatic contradiction, and the value 90−10=80 rpro is propagated to hypothesis 127.

The value of 80 pro is combined with rpro/rcon=70/30 of hypothesis 127. (70+80)/(100+80)=0.833*100=83.3(83)0.30/(100+80)=0.166*100=16.6(17). Hypothesis 127 becomes rpro/rcon=83/17.

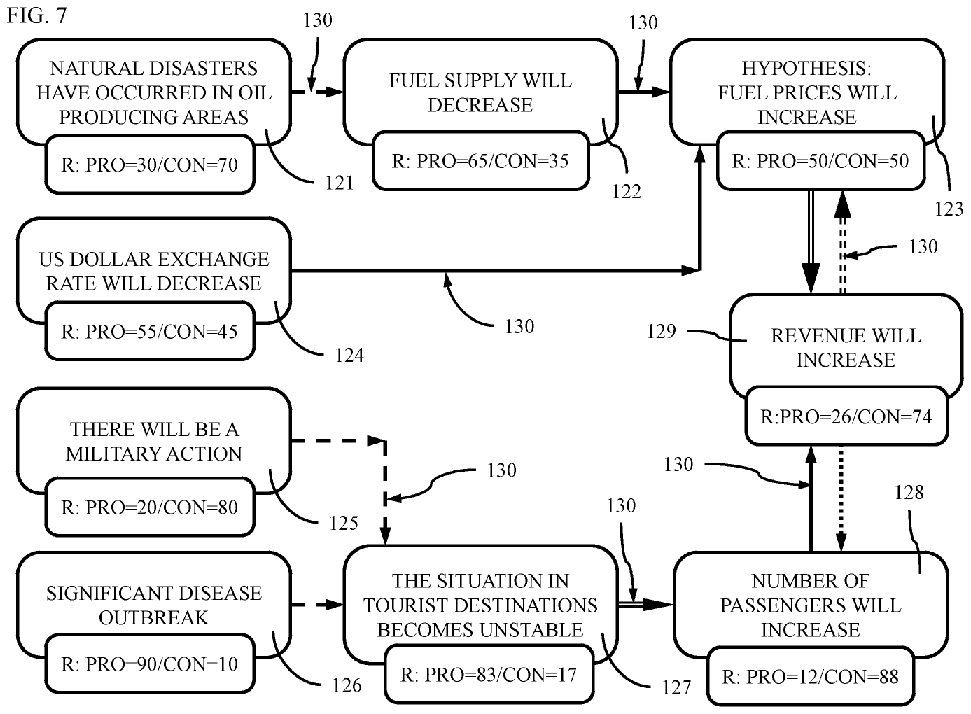

FIG. 7 is a block/flow diagram showing propagated r-scores from the pro/con scores for a hypothesis and topics provided, in accordance with an embodiment of the present invention.

For hypothesis 128, a value of 83−17=66 pro is propagated from hypothesis 127 to hypothesis 128. The value of 66 from hypothesis 127 is combined with the con value of 80 from hypothesis 128, 80+66=146, and evaluated. (80+66)/(100+66)=146/166=0.879*100=87.9(88). Pro=20/(100+66)=20/166=0.120*100=12.

For hypothesis 129, a value of 88−12=76 con is propagated from hypothesis 128 to hypothesis 129. Because the value of rpro/rcon=50/50 for hypothesis 123, no value (0) is propagated. The con value for hypothesis 129 is then calculated as (55+76)/(100+76)=131/176=0.744*100=74.4(74). The pro value is 45/(100+76)=45/176=0.255*100=25.5(26).

The calculated values for rpro/rcon of hypothesis 129 is 26/74.

As a different example, if hypothesis 123, was scored as rpro/rcon=40/60. Because rcon is larger, 60−40=20, which is forwarded to hypothesis 129. For hypothesis 128, rpro/rcon=20/80. Because rcon is larger, 80−20=60, which would also be forwarded to hypothesis 129.

The values for hypothesis 128 is expected to have a positive influence (as represented by the single line) on the results of hypothesis 129, where an increase in passengers would be expected to increase in revenues. Conversely, the values for hypothesis 123 is expected to have a negative influence (as represented by the double line) on the results of hypothesis 129, where an increase in fuel prices is expected to decrease revenues because of an increase in costs. The negative of a negative is a positive, so the con value of 20 from hypothesis 123 is propagated as rpro=20. The con value of 40 from hypothesis 128 is propagated as rcon=40. There are no other influences on hypothesis 129.

The values for rpro and rcon from hypothesis 123 and hypothesis 128 have opposite influences, so their value cancel each other out, where 40−20=20. For hypothesis 129 in the root node, rpro/rcon=45/55. The newly calculated value becomes 45/(100+20)*100=(45/120)*100=37.5(38); and (55+20)/(100+20)*100=(75/120)*100=62.5(62). The values for hypothesis 129 therefore becomes 38/62.

A score of 50/50 would result in a calculation of 50−50=0, so would have no influence on the scores of the hypothesis being propagated to.

Supervenience represent the interdependence of different hypothesis. The supervenience relation expresses the constraint between the hypotheses that we want to impose on the causal model. Introducing the relationship that hypothesis H1 supervenes on hypothesis H2 into the model means that we are imposing the constraint that we will only consider situations where hypothesis H1 can be supported (or cannot be supported) if hypothesis H2 is supported (not supported). In score propagation, only scores that satisfy these circumstances can affect the scores of other hypotheses. When hypothesis H1 positively supervenes on hypothesis H2, the pro-score of H1 can be greater than the con-score of H2 only when the pro-score of H2 is greater than or equal to the con-score of H2 (and the con-score of H1 can be greater than the pro-score of H1 only when the con-score of H2 is greater than or equal to the pro-score of H2). When this constraint is not met, both the pro-score and con-score of H1 are reset to 50. When the constraint is satisfied, there is no change in the scores of H1 and H2 due to this supervenience relationship.

A negative causation also can be considered: negative contribution, implication and supervenience, which provide a negative impact on arising of target event (affecting it in the form of replacing positive(ly) with negative(ly) in the underlined portion above.

A pros/cons score propagation algorithm based on the axioms is applied to three causation types: Axiom for supervenience, Axiom for contribution, and Axiom for implication.

Axioms (or constraints) formally express the reasonable pros/cons degree for hypotheses related to each other with the three types of causation.

Axiom for supervenience: if A (positively) supervenes B1, . . . , Bn and negatively supervenes C1, . . . , Cm, then the followings must be hold:—if A.rpro>A.rcon then, [symbol] i. Bi.rpro>=Bi.rcon for i in 1 . . . n or [symbol] j. Cj.rcon>=Cj.rpro for j in 1 . . . m.

if Arcon>A.rpro then, [symbol] i. Bi.rcon>=Bi.rpro for i in 1 . . . n or [symbol] j. Cj.rpro>=Cj.rcon for j in 1 . . . m.

[symbol] i.=“there exists an i where . . . ”

Axiom for contribution: if A (positively) contributes to B1, . . . , Bn, negatively contributes to C1, . . . , Cm, and D.tpro=D.tcon for all other D such that D has causation to Bi or Cj for i=0 . . . n and j=0 . . . m, then the followings hold:—if A.tpro>A.tcon then, Bi.rpro>Bi.tpro for all i=1 . . . n and Cj.tpro>Cj.rpro for j=1 . . . m

if A.tcon>A.tpro then, Bi.rcon>Bi.tcon for all i=1 . . . n and Cj.tcon>Cj.rcon for j=1 . . . m

Axiom for implication: if A (positively) implies B1, . . . , Bn and negatively implies C1, . . . , Cm, and D.tpro=D.tcon for all other D such that D has causation to Bi or Cj for i=0 . . . n and j=0 . . . m, then the followings hold:—if A.tpro>A.tcon then, Bi.rpro>Bi.tpro for all i=1 . . . n and Cj.tpro>Cj.rpro for j=1 . . . m

if A.tpro<=A.tcon then, Bi.rpro=Bi.tpro for all i=1 . . . n and Cj.tpro=Cj.rpro for j=1 . . . m

Input: (i1) a causal relationship model composed of hypothesis nodes and causations, and

(i2) an external scoring function for providing pro/con score for a hypothesis and topics

Output: (o1) Reasoned score (propagated score) for each hypothesis.

Input (i1) a causal relationship model composed of hypothesis nodes and causations.

(i2) an external scoring function for providing pro/con score for a hypothesis and topics.

(i3) particular name (optional, for example company name).

A user can obtain an external score [g-score] for each node using the external scoring function for providing pro/con score for a hypothesis and topics.

If a particular name is provided by the user, the particular name can be added (by i3) into topics of every node, and an external score [s-score] obtained using the external scoring function.

In various embodiments, if no singular name is provided, then the g-score is regarded as the t-score.

The t-score of each node can be set equal to the propagated score (r-score) of each node.

Reset [r-score] to pro/con=50/50 for nodes A,Bi s.t. A supervenes B1, . . . Bk and A,B1, . . . , Bk violates axiom-SV. For r-scores of two hypotheses that are set to 50/50 because they violate axiom-SV, the resultant external scores (s-, g-scores) for the hypotheses are not considered.

The pro/con score([r-score]) can be propagated continuously from leaf nodes to the root nodes on the model based on the causation types in a way that satisfies Axiom-Prop-C, Prop-I. For propagation, for a node B s.t. A—positive-contribution→B and A,B tpro/tcon is [80/20], [60/40], respectively. r-score of B is computed like B.rpro=(60+(80−20))/(100+60) and B.rcon=100−B.rpro.

If there are nodes which do not satisfy [Axiom SV], reset the [r-score] to pro/con=50/50 for nodes A, Bi., otherwise output the [r-score] of each node.

In a non-limiting exemplary embodiment, a user can input a causal relationship model, where the user identifies an occurrence or event and a plurality of hypothesis believed by the user to have a causal relationship with the occurrence or event. For example, a use may wish to determine whether the revenue for a particular airline will increase over a predetermined time period. The user identifies a plurality of related factors that the user believes have an influence on airline revenue, for example, a change in fuel prices, passenger demand for flights, and growth of the economy.

In various embodiments, to determine the likelihood or unlikelihood of the hypothesized occurrences happening, an external scoring function can be employed to generate pro and con scores from external sources. External sources can be economic reports, news articles and news broadcast transcripts, company financial reports, and government publications. These external sources can undergo sentimental analysis using, for example, neural networks, natural language processing, and hypothesis opinion extractor. The hypotheses can be scored in the form of pro/con ratios based on the external scores for each hypothesis.

A pro/con score can be obtained based on information from the news article store, then a pro/con score can be obtained for only those articles in the news article store that contain a particular name, and those scores can be merged to determine the specific-name-considering score for the hypothetical statement related to the particular name.

In general, there are few articles that contain a specific name (company name), etc.; therefore, scoring based only on articles that contain only specific names may not be effective. Therefore, in order to obtain a score based on a specific name (company name), but on many articles, using both general information from the news article and articles in the news article store that contain the particular name can be effective.

In one or more embodiments, each node represents a hypothesis. Each hypothesis contains hypothesis text and topic words. Hypothesis text is evaluated in a context related to the topic, for example, a hypothesis is evaluated based on the news articles containing all of the identified topic words.

In various embodiments, each edge expresses a causation relating two hypothesis, where there can be three causation types. A positive contribution (causation), where hypothesis A positively contributes to the arising or non-arising of hypothesis B. A positive implication, where the occurrence of A positively contributes to the arising of hypothesis B. A positive supervenience, where unless there is an overall positive impact on the arising of hypothesis B, there is no positive impact on the arising of hypothesis A. The relation that hypothesis H1 is positively supervene on hypothesis H2 (H1→H2) represents here the constraint that the following relation between the causal hypothesis H1 and the outcome hypothesis H2 must hold: (1) If H2 is supported by the score (i.e., the pro score of H2 is greater than the con score), then H1 must not be disapproved by the score (i.e., the pro score of H1 must be greater than or equal to the con score); (2) Also, if H2 is not supported on the score (i.e., H2's con score is greater than its pro score), then H1 must not be supported on the score (i.e., H1's con score must be greater than or equal to its pro score).

For example, in a certain situation, hypothesis H1 can be considered to have a positive contributory causal effect on H2 for hypothesis H1 “US interest rate will rise” and hypothesis H2 “exchange rate USD/JPY will rise”. This means that if the likelihood that US interest rates will rise increases, the likelihood that the exchange rate USD/JPY will rise increases, and if the likelihood that US interest rates will fall increases, the likelihood that the exchange rate USD/JPY will fall increases. As for the positive implication relation, for example, for the hypotheses H1 “there will be a global pandemic” and H2 “airline revenues will decline”, we can think that H1 would imply H2. This is intended to be a relationship such that if H1 holds, then the likelihood of H2 holding increases, but if H1 is not held, then the likelihood of H2 holding does not necessarily decrease. As for the supervenience, for example, for hypothesis H1 “USD/JPY will rise” and hypothesis H2 “US interest rates will rise”, we can consider the relationship that H1 supervenes on H2. This supervenience relationship represents a situation where if hypothesis H2 holds (or does not hold), then hypothesis H1 holds (or does not hold). This supervenience implies that only such a situation is considered, and if the scores of hypotheses H1 and H2 do not reflect such a situation, their hypothesis scores are removed from consideration as unreliable, meaning that they are not the situation we are currently considering, i.e., the pro and con scores are both set to 50. core will both be set to 50.

There are three types of axioms:

1) Axiom SV for supervenience; if hypothesis A positively supervenes hypothesis B and negatively supervenes hypothesis C, then if A.rpro (reasoned/propagated pro score of hypothesis A)>A.rcon (reasoned/propagated con score of hypothesis A), then Bi.rpro>=Bi.rcon for i . . . n, or Cj.rcon>=Cj.rpro for j . . . m; or if A.rcon (reasoned/propagated pro score of hypothesis A)>A.rpro (reasoned/propagated con score of hypothesis A), then Bi.rcon>=Bi.rpro for i . . . .n, or Cj.rpro>=Cj.rcon for j . . . m.

2) Axiom Prop-C for contribution; if hypothesis A positively contributes to hypothesis B and negatively contributes hypothesis C, then

A user can use the propagated scores, which incorporate knowledge of causal relationships, for prediction of events or occurrences.

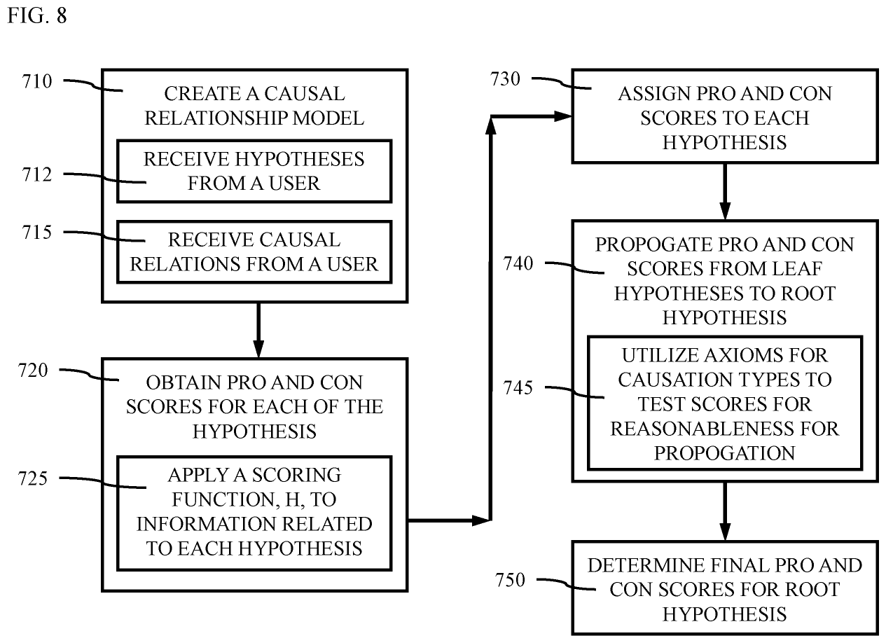

FIG. 8 is a block/flow diagram showing a method of obtaining a prediction for a root node, in accordance with an embodiment of the present invention.

At block 710 a causal relationship model can be generated from hypotheses 712 and causal relationships 715 received from a user. A user can enter the text of the hypothesis and one or more keywords associated with each of the hypotheses. The user can also identify the causal relationship between each pair of hypothesis, such that a particular formula can be used to relate the information obtained for each hypothesis.

At block 720 the system can obtain pro and con sentiment scores for each of the hypotheses, where the pro and con scores can be obtained from, for example, news articles that contain the identified key words. A scoring function, H, 725 can be used to generate the pro and con sentiment scores for each of the hypotheses based on the key words. The key words can include a specific name of an entity or place.

At block 730, the obtained pro and con sentiment scores can be assigned to their respective hypothesis, where the scores are related to the text of the hypothesis and the identified key words.

At block 740, the pro and con sentiment scores can be propagated from the leaf nodes towards the root node using the causal relationships and axioms for the different causation types 745 to determine which pro and con scores are propagated and the calculations used to propagate the pro and con scores.

At block 750, the pro and con scores generated through propagation for each of the hypotheses, including the root node can be determined. The final pro and con scores can hen be presented to the user as a prediction or likelihood of the occurrence of each of the hypotheses, including the root hypothesis.

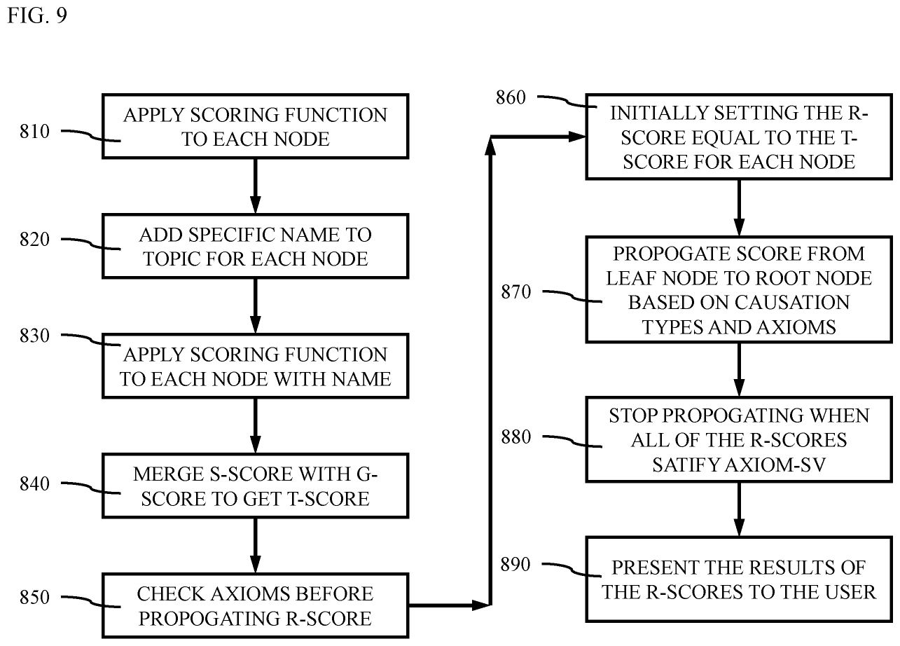

FIG. 9 is a block/flow diagram showing a method of propagating the pro and con sentiment scores, in accordance with an embodiment of the present invention.

At block 810, a scoring function can be applied to the hypothesis of each node to obtain a g-pro score and a g-con score (gpro, gcon). Sentiment analysis can be applied to news information to obtain the pro and con scores.

At block 820, a specific name can be added to the topic words of the hypothesis of each node.

At block 830, the a scoring function can be applied to the hypothesis including the specific name of each node to obtain an s-pro score and an s-con score (spro, scon). Sentiment analysis can be applied to news information to obtain the pro and con scores.

At block 840, the g-scores and the s-scores can be merged for each node, where:

tpro=(gpro+spro)/2;

tcon=(gcon+scon)/2.

At block 850, the tpro/tcon score of each node is evaluated against Axiom-SV to determine if the scores do not have support in view of the axiom. If the scores of hypotheses related by a causation are found to not be supported under Axiom-SV, the tpro/tcon score is set to 50/50 and propagated as a reasoned score (r-score (rpro/rcon)) to indicate that the scores are not being considered.

At block 860, the r-scores are set equal to the t-scores for the hypotheses that did meet the requirements of Axiom-SV.

At block 870, the r-scores are propagated from the leaf nodes to the root node model based on the causation types in a way that satisfies Axiom-C and Axiom-I.

At block 880, the r-scores are again evaluated against Axiom-SV, and the propagation ends when all the r-scores for all the nodes are supported by Axiom-SV.

At block 890, the final results for all of the r-scores can be presented to a user, as a likelihood or prediction of the occurrence of the hypothetical events. The user can make decisions and act on the scores and predictions, and take actions based on the decisions and predictions.

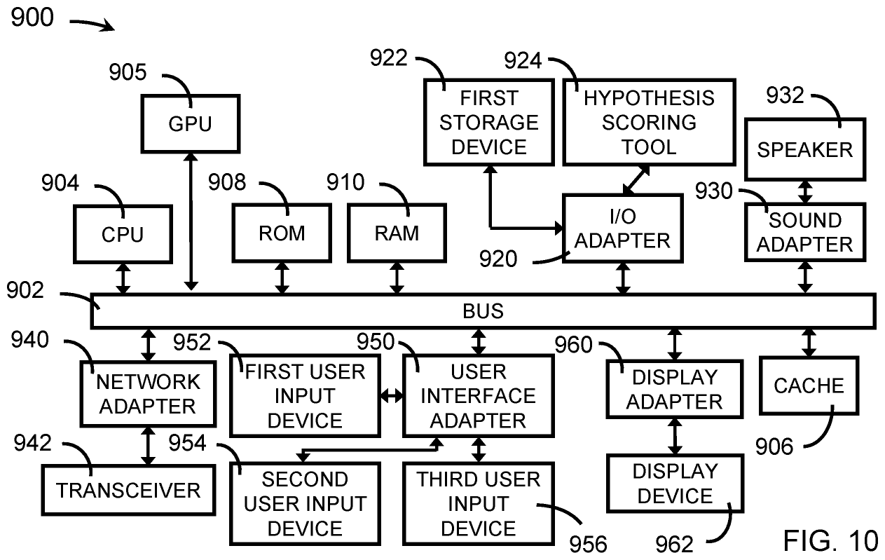

FIG. 10 is an exemplary processing system to which the present methods and systems may be applied, in accordance with an embodiment of the present invention.

The processing system 900 can include at least one processor (CPU) 904 and may have a graphics processing (GPU) 905 that can perform vector calculations/manipulations operatively coupled to other components via a system bus 902. A cache 906, a Read Only Memory (ROM) 908, a Random Access Memory (RAM) 910, an input/output (I/O) adapter 920, a sound adapter 930, a network adapter 940, a user interface adapter 950, and/or a display adapter 960, can also be operatively coupled to the system bus 902.

A first storage device 922 and a second storage device 924 are operatively coupled to system bus 902 by the I/O adapter 920, where a tool for molecular optimization can be stored for implementing the features described herein. The storage devices 922 and 924 can be any of a disk storage device (e.g., a magnetic or optical disk storage device), a solid state storage device, a magnetic storage device, and so forth. The storage devices 922 and 924 can be the same type of storage device or different types of storage devices. The hypothesis scoring tool can be stored in the storage device 924 and implemented by the at least one processor (CPU) 904 and/or the graphics processing (GPU) 905.

A speaker 932 can be operatively coupled to the system bus 902 by the sound adapter 930. A transceiver 942 can be operatively coupled to the system bus 902 by the network adapter 940. A display device 962 (e.g., computer monitor) can be operatively coupled to the system bus 902 by display adapter 960.

A first user input device 952, a second user input device 954, and a third user input device 956 can be operatively coupled to the system bus 902 by the user interface adapter 950. The user input devices 952, 554, and 956 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 952, 954, and 956 can be the same type of user input device or different types of user input devices. The user input devices 952, 954, and 956 can be used to input and output information to and from the processing system 900.

In various embodiments, the processing system 900 may also include other elements (not shown), as readily contemplated by one of skill in the art, as well as omit certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 900 are readily contemplated by one of ordinary skill in the art given the teachings of the present principles provided herein.

Moreover, it is to be appreciated that system 900 is a system for implementing respective embodiments of the present methods/systems. Part or all of processing system 900 may be implemented in one or more of the elements of FIGS. 1-9. Further, it is to be appreciated that processing system 900 may perform at least part of the method(s) described herein including, for example, at least part of the method(s) of FIGS. 1-9.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment”, as well as other variations thereof, means that a particular feature, structure, characteristic, and so forth described in connection with the embodiment is included in at least one embodiment. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms such as “beneath,” “below,” “lower,” “above,” “upper,” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer implemented method of hypothesis scoring based on causal relationships, comprising:
creating a causal relationship model utilizing a plurality of hypotheses and a causal relationship between each of two or more pairs of hypotheses;
obtaining pro and con sentiment scores for each hypothesis utilizing a scoring function;
assigning the obtained pro and con sentiment scores to each hypothesis in the causal relationship model;
propagating the pro and con sentiment scores from leaf hypotheses to a root hypothesis utilizing axioms to test the propagating scores for reasonableness;
determining a final pro and con score for the root hypothesis; and
presenting the final pro and con scores representing a prediction of the hypotheses to a user.

2. The computer implemented method of claim 1, wherein the causal relationship is a contribution, an implication, or a supervenience that determines a method of propagating the pro and con scores.

3. The computer implemented method of claim 2, wherein an axiom for each of contribution, implication, and supervenience is applied to the pro and con score for each propagation.

4. The computer implemented method of claim 3, wherein the causal relationship model includes one or more topic words including a specific name with each of the plurality of hypotheses.

5. The computer implemented method of claim 4, wherein pro and con sentiment scores are calculated for each of the plurality of hypotheses both with and without the specific name to produce g-scores and s-scores, and the g-scores and s-scores are merged.

6. The computer implemented method of claim 5, wherein the pro and con sentiment scores are obtained by applying the scoring function to news articles.

7. The computer implemented method of claim 6, wherein the pro and con sentiment scores are propagated by subtracting the smaller of either the pro or con sentiment score from the larger of the pro or con sentiment score and adding the different to a same pro or con sentiment score of a down-stream hypothesis.

8. A computer system implementing a hypothesis scoring method based on causal relationships, comprising:
one or more processors;
a display operationally coupled to the one or more processors; and
a computer memory operationally coupled to the one or more processors, wherein a hypothesis scoring tool is stored in the computer memory and configured to create a causal relationship model utilizing a plurality of hypotheses and a causal relationship between each of two or more pairs of hypotheses;
obtain pro and con sentiment scores for each hypothesis utilizing a scoring function;
assign the obtained pro and con sentiment scores to each hypothesis in the causal relationship model;
propagate the pro and con sentiment scores from leaf hypotheses to a root hypothesis utilizing axioms to test the propagating scores for reasonableness;
determine a final pro and con score for the root hypothesis; and
present the final pro and con scores representing a prediction of the hypotheses to a user.

9. The computer system of claim 8, wherein the causal relationship is a contribution, an implication, or a supervenience that determines a method of propagating the pro and con scores.

10. The computer system of claim 9, wherein an axiom for each of contribution, implication, and supervenience is applied to the pro and con score for each propagation.

11. The computer system of claim 10, wherein the causal relationship model includes one or more topic words including a specific name with each of the plurality of hypotheses.

12. The computer system of claim 11, wherein pro and con sentiment scores are calculated for each of the plurality of hypotheses both with and without the specific name to produce g-scores and s-scores, and the g-scores and s-scores are merged.

13. The computer system of claim 12, wherein the pro and con sentiment scores are obtained by applying the scoring function to news articles.

14. The computer system of claim 13, wherein the pro and con sentiment scores are propagated by subtracting the smaller of either the pro or con sentiment score from the larger of the pro or con sentiment score and adding the different to a same pro or con sentiment score of a down-stream hypothesis.

15. A computer program product for implementing a hypothesis scoring method based on causal relationships, the computer program product comprising a computer readable storage medium having program instructions embodied therewith, the program instructions are executable by a processor to cause a computer to:
create a causal relationship model utilizing a plurality of hypotheses and a causal relationship between each of two or more pairs of hypotheses;
obtain pro and con sentiment scores for each hypothesis utilizing a scoring function;
assign the obtained pro and con sentiment scores to each hypothesis in the causal relationship model;
propagate the pro and con sentiment scores from leaf hypotheses to a root hypothesis utilizing axioms to test the propagating scores for reasonableness;
determine a final pro and con score for the root hypothesis; and
present the final pro and con scores representing a prediction of the hypotheses to a user.

16. The computer program product of claim 15, wherein the causal relationship is a contribution, an implication, or a supervenience that determines a method of propagating the pro and con scores.

17. The computer program product of claim 16, wherein an axiom for each of contribution, implication, and supervenience is applied to the pro and con score for each propagation.

18. The computer program product of claim 17, wherein the causal relationship model includes one or more topic words including a specific name with each of the plurality of hypotheses.

19. The computer program product of claim 18, wherein pro and con sentiment scores are calculated for each of the plurality of hypotheses both with and without the specific name to produce g-scores and s-scores, and the g-scores and s-scores are merged.

20. The computer program product of claim 19 wherein the pro and con sentiment scores are obtained by applying the scoring function to news articles.
